(19) United States
(12) Patent Application Publication
(10) Pub. No.: US 2010/0149712 A1
(43) Pub. Date: Jun. 17, 2010

(54) Digital Overcurrent Protection Device for a Power Supply Device and Related Power Supply Device

(76) Inventors: Yen-Hui Wang, Hsinchu City (TW); Chi-Hao Wu, Taipei City (TW); Chia-Chieh Hung, Taoyuan County (TW); Yu-Min Shih, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/336,522

(22) Filed: Dec. 16, 2008

(51) Int. Cl. H02H 3/08

(52) U.S. Cl. 361/93.2

(57) ABSTRACT

A digital overcurrent protection device for a power supply device includes a receiving end for receiving a current sensing signal, a digital reference voltage generator for digitally generating a reference voltage, a comparator coupled between the receiving end and the digital reference voltage generator for comparing the current sense signal with the reference voltage in order to generate a comparison result, and a control unit coupled to the comparator for controlling a power switch of the power supply device according to the comparison result.

### BACKGROUND OF THE INVENTION

1. Field of the Invention

The present invention relates to a digital overcurrent protection device for a power supply device and related power supply device, and more particularly, to a digital overcurrent protection device and related power supply device capable of achieving an identical voltage for an overcurrent limit corresponding to each input voltage by digitally adjusting a reference voltage.

2. Description of the Prior Art

Power supplies are utilized for supplying electrical energy for electronic devices, and can be generally divided into linear power supplies and switching power supplies. Compared to the linear power supplies, the switching power supplies have advantages of smaller size, lighter weight, and greater efficiency, so as to be widely applied to different areas, such as mobile communication devices, personal digital assistants, computers and related peripheral devices, servers, and network devices.

Protection schemes, such as overvoltage protection, overcurrent protection, and overpower protection, etc., play a very important role in a control circuit of a power supply for safe operation of the power supply. Power supplies that have comprehensive protection schemes can prevent internal elements and related devices from being damaged under current overload or short circuit conditions.

Please refer to FIG. 1. FIG. 1 is a schematic diagram of a power supply 100 in the prior art. The power supply 100 includes a transformer 102, a power switch 104, a current sensing unit 106, a comparator 108, and a pulse width modulation control unit 110. The transformer 102 includes a primary side circuit L₁ and a secondary side circuit L₂ for transforming an input signal V_{IN} into an output signal V_{OUT}. The power switch 104 is coupled to the primary side circuit L₁ for controlling operations of the transformer 102. As shown in FIG. 1, the power switch 104 is implemented by a power transistor Q1. The pulse width modulation control unit 110 is utilized for controlling on/off status of the power switch 104 by outputting a control signal. The current sensing unit 106 is coupled to the drain of the power transistor Q1, and implemented by a current sensing resistor R_{CS} for providing a current sensing signal V_{CS} in order to detect current I_{L1} passing through the primary side circuit of the power transistor Q1. The comparator 108 is utilized for comparing the current sense signal V_{CS} with a reference voltage V_{REF} in order to provide a result for the pulse width modulation control unit 110 to determine whether the overcurrent condition exists. For example, when the current sensing signal V_{CS} is higher than the reference voltage V_{REF}, the comparator 108 can pass an indication signal S_{OC} to the pulse width modulation control unit 110. The pulse width modulation control unit 110 then enables to turn off the power transistor Q1 in order to reduce the current I_{L1} passing through the primary side circuit. In general, the reference voltage V_{REF} is generated by a reference voltage generator, and is a constant value.

In the power supply 100, the above protection scheme can keep the current within a proper range by comparing the current sensing signal V_{CS} with the reference voltage V_{REF}. However, when the current sensing signal V_{CS} is higher than the reference voltage V_{REF}, the power switch 104 can not turn off immediately due to non-ideal factors. Actually, the pulse width modulation control unit 110 may enable to turn off the power switch 104 after a non-ideal delay. As a result, since the overcurrent condition exists until the power switch 104 actually turns off, there exists a propagation delay time T_{delay} in which the current will be higher than a predetermined value. In other words, a voltage of actual initial overcurrent protection (protection voltage) is usually higher than a voltage corresponding to occurrence of the overcurrent condition (i.e. V_{REF}), and the protection voltages will be different for each input voltage V_{IN}.

In detail, FIG. 2 is a schematic diagram of protection voltage differences for different input voltages due to propagation delay. The input signal V_{IN} of the power supply 100 is proportional to the rising slope of the current sensing signal V_{CS}. Therefore, a high input voltage V_{H} will generate a current sensing signal with greater slope and a low input voltage V_{L} will generate a current sensing signal with smaller slope. The reference voltage is V_{REF}. Moreover, there is a same propagation delay time T_{delay} in the same power supply. The propagation delay time T_{delay} is irrelevant to the input signal V_{IN}. As shown is FIG. 2, as the current sensing signal V_{CS} rises to a power limit level of the reference voltage V_{REF}, the comparator 108 passes an indication signal S_{OC} to the pulse width modulation control unit 110 so as to turn off the power transistor Q1. After a propagation delay time T_{delay} during which the power switch 104 is turned off, the current I_{L1} passing through the primary side circuit is disabled. As shown in FIG. 2, since the overcurrent condition exists until the power switch 104 actually turns off, the input signal continues to provide power, so that the high input voltage V_{H} has a corresponding protection voltage V_{OPPH} and the low input voltage V_{L} has a corresponding protection voltage V_{OPPL}. Therefore, the protection voltage will be higher than the reference voltage V_{REF}, and the difference increases as the input signal becomes higher due to constant reference voltage V_{REF}. In such a situation, when the power supply operates over a wide range (AC input voltage ranges from 90 Vac to 264 Vac), the protection voltage may vary obviously, and the output powers for the high input voltage and the low input voltage will be largely distinct from each other.

### SUMMARY OF THE INVENTION

It is therefore a primary objective of the claimed invention to provide a digital overcurrent protection device for a power supply device and related power supply device.

The present invention discloses a power supply device with overcurrent protection. The power supply device comprises an input stage, a transformer, a power switch, a current sensing unit, an output stage, and a digital overcurrent protection device. The input stage is utilized for filtering and rectifying an input signal in order to generate a first power signal. The transformer having a primary side circuit is coupled to the input stage and a secondary side circuit, for transforming the first power signal into a second power signal. The power switch is coupled to the primary side circuit. The current sensing unit is coupled to the power switch for detecting currents passing through the primary side circuit of the power switch in order to generate a current sensing signal. The output stage is coupled to the transformer for outputting the second power signal to a load. And the digital overcurrent protection device is coupled to the current sensing unit and the power switch. The digital overcurrent protection device comprises a receiving end, a digital reference voltage generator, a comparator, and a control unit. The receiving end is utilized for receiving the current sensing signal. The digital reference voltage generator is utilized for digitally generating a reference voltage. The comparator is coupled between the receiving end and the digital reference voltage generator for comparing the current sensing signal with the reference voltage in order to generate a comparison result. And the control unit is coupled to the comparator and the power switch for controlling an on/off status of the power switch according to the comparison result.

The present invention further discloses a digital overcurrent protection device for a power supply device. The digital overcurrent protection device comprises a receiving end, a digital reference voltage generator, a comparator, and a control unit. The receiving end is utilized for receiving a current sensing signal. The digital reference voltage generator is utilized for digitally generating a reference voltage. The comparator is coupled between the receiving end and the digital reference voltage generator for comparing the current sensing signal with the reference voltage in order to generate a comparison result. And, the control unit is coupled to the comparator for controlling an on/off status of a power switch of the power supply device according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power supply in the prior art.

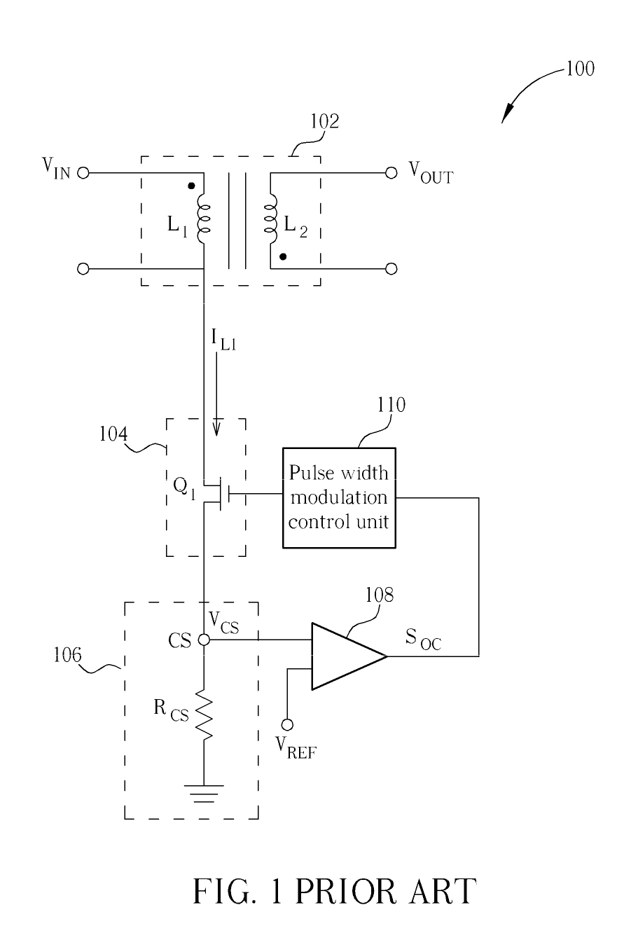

FIG. 2 is a schematic diagram of protection voltages difference for different input voltage due to propagation delay.

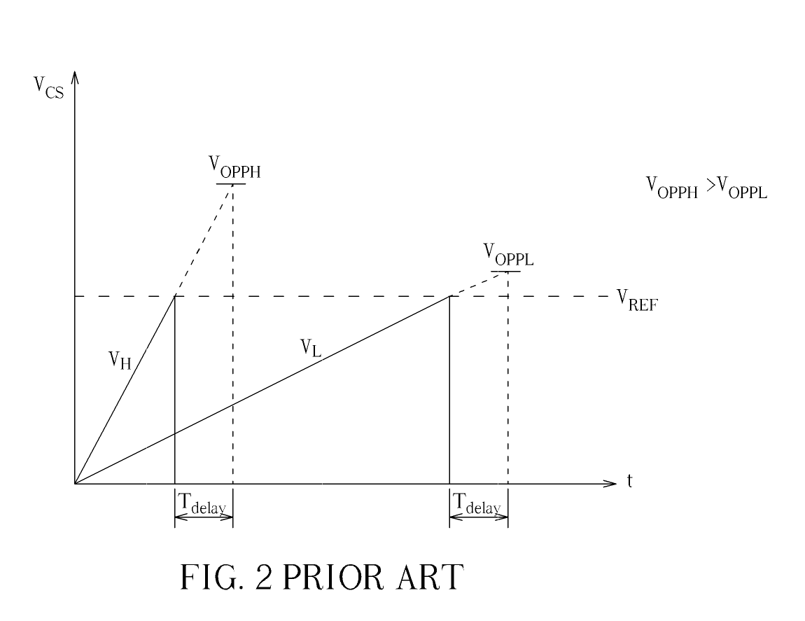

FIG. 3 is a schematic diagram of a power supply according to an embodiment of the present invention.

FIG. 4 is a schematic diagram of the protection voltage improvement of the overcurrent protection device according to an embodiment of the present invention.

FIG. 5 is a schematic diagram of the digital reference voltage generator shown in FIG. 3 according to a preferred embodiment of the present invention.

FIG. 6 is a schematic diagram of the digital-to-analog converter shown in FIG. 5 according to an embodiment of the present invention.

### DETAILED DESCRIPTION

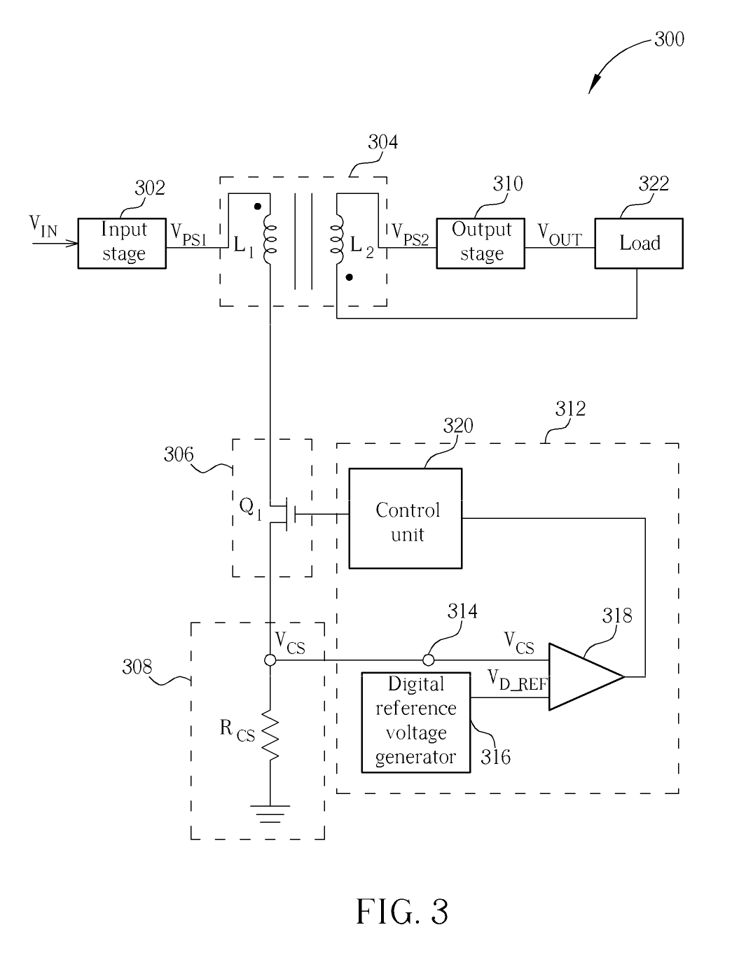

Please refer to FIG. 3. FIG. 3 is a schematic diagram of a power supply 300 according to an embodiment of the present invention. The power supply 300 includes an input stage 302, a transformer 304, a power switch 306, a current sensing unit 308, an output stage 310, and an overcurrent protection device 312. The input stage 302 is utilized for filtering and rectifying an input signal V_{IN} in order to generate a first power signal V_{PS1}. The transformer 304 is coupled to the input stage 302, which has a primary side circuit L₁ and a secondary side circuit L₂. The transformer 304 is utilized for transforming the first power signal V_{PS1} into a second power signal V_{PS2}. The power switch 306 is coupled to the primary side circuit L₁ for switching operation of the transformer 304, which is preferably implemented by a power transistor Q1. The current sensing unit 308 is coupled to the power switch 306 for detecting current passing through the primary side circuit L₁ in order to generate a current sensing signal V_{CS}, which is preferably implemented by a resistor R_{CS}. The output stage 310 is coupled to the transformer 304 for outputting the second power signal V_{PS2} to a load 322. The overcurrent protection device 312 is coupled to the power switch 306 and the current sensing unit 308 for monitoring whether a current I_{L1} of the primary side is within the protected range. While the current I_{L1} is higher than the protected range, the power switch 306 may be turned off for performing overcurrent protection.

Regarding structure and operation of the overcurrent protection device 312 shown in FIG. 3, the overcurrent protection device 312 includes a receiving end 314, a digital reference voltage generator 316, a comparator 318, and a control unit 320. The receiving end 314 is coupled to the current sensing unit 308 for receiving the current sensing signal V_{CS}. The digital reference voltage generator 316 is utilized for digitally generating a reference voltage V_{D}_{_{—}}_{REF}. The comparator 318 is coupled between the receiving end 314 and the digital reference voltage generator 316 for comparing the reference voltage V_{D}_{_{—}}_{REF} with the current sensing signal V_{CS} in order to generate a comparison result. The control unit 320 is coupled to the comparator 318 and the power switch 306 for controlling an on/off status of the power switch 306 according to the comparison result. Furthermore, when the comparison result indicates the current sensing signal V_{CS} is higher than or equal to the reference voltage V_{D}_{_{—}}_{REF}, the control unit 320 enables to turn off the power switch 306. Other than that, when the comparison result indicates that the current sensing signal V_{CS} is lower than the reference voltage VD-REF, the control unit 320 keeps the power switch 306 on.

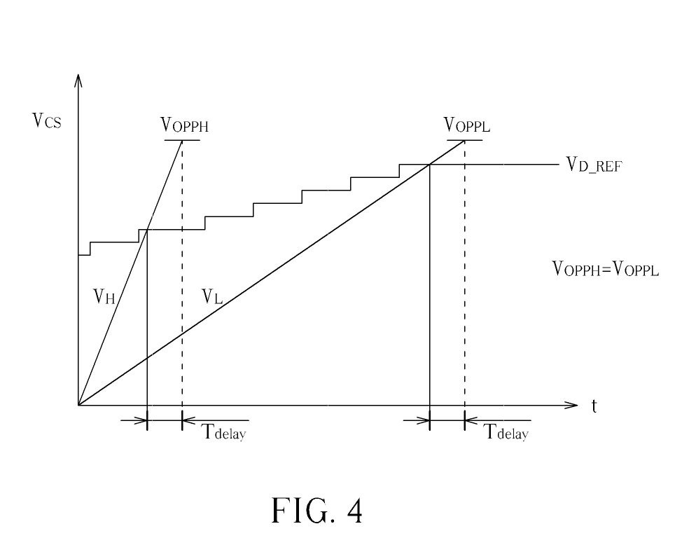

The present invention provides various digital reference voltages V_{D}_{_{—}}_{REF} by the digital reference voltage generator 316 digitally. Please further refer to FIG. 4. FIG. 4 is a schematic diagram of the protection voltage improvement of the overcurrent protection device 312 according to an embodiment of the present invention. Propagation delay time T_{delay} is the same for each input voltage. As shown in FIG. 4, the digital reference voltage generator 316 is utilized for digitally generating the reference voltage VD-REF, so that various input voltages have their corresponding reference voltage V_{D}_{_{—}}_{REF}. Thus, after the growing sensing signal V_{CS} reaches the reference voltage V_{D}_{_{—}}_{REF}, the overcurrent protection device 312 activates the overcurrent protection. As a result, the power supply 300 can save power during the propagation delay time T_{delay}. There are also identical voltages for the overcurrent limit under the high input voltage V_{H} and the low input voltage V_{L}.

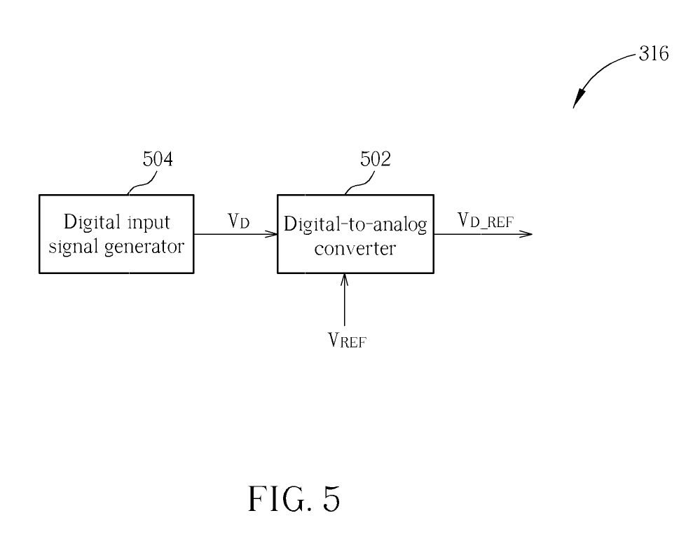

Note that FIG. 3 is a schematic diagram according to an exemplary embodiment of the present invention, and those skilled in the art can make alterations and modifications accordingly. For example, please refer to FIG. 5. FIG. 5 is a schematic diagram of the digital reference voltage generator 316 shown in FIG. 3 according to a preferred embodiment of the present invention. Regarding operation of the digital reference voltage generator 316, the digital reference voltage generator 316 includes a digital-to-analog converter 502, a digital input signal generator 504, and a predetermined reference voltage V_{REF}. The digital-to-analog converter 502 is utilized for converting a digital input signal VD into a corresponding predetermined reference voltage V_{D}_{_{—}}_{REF}. The digital input signal generator 504 is utilized for generating the digital input signal V_{D}. Preferably, the digital reference voltage generator 316 adjusts the digital input signal V_{D} according to different system requirements of different power supplies for outputting the corresponding reference voltage V_{D}_{_{—}}_{REF} to the comparator 318. The comparator 318 compares the reference voltage V_{D}_{_{—}}_{REF} with the current sensing signal V_{CS} in order to generate a comparison result, and transmits the comparison result to the control unit 320. The control unit 320 controls on/off status of the power switch 306 according to the comparison result. In addition, the digital reference voltage generator 316 is preferably capable of adjusting the digital input signal V_{D} according to variation of the current sensing signal V_{CS}. That is, the power supply 300 can select a proper digital input signal V_{D} according to the tendency of the current sensing signal V_{CS} to rise after the current sensing unit 308 operates for some time. Again, the digital-to-analog converter 502 converts the digital input signal V_{D} to a corresponding predetermined reference voltage V_{D}_{_{—}}_{REF}.

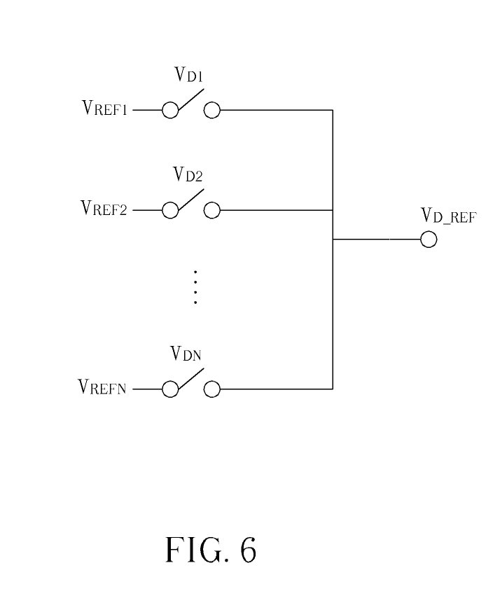

Note that FIG. 5 is a schematic diagram according to an exemplary embodiment of the present invention, and those skilled in the art can make alterations and modifications accordingly. For example, please refer to FIG. 6. FIG. 6 is a schematic diagram of the digital-to-analog converter 502 shown in FIG. 5 according to an embodiment of the present invention. In FIG. 6, the digital-to-analog converter 502 includes switches V_{D1}˜V_{DN} and predetermined reference voltages V_{REF1}˜V_{REFN} for conducting the corresponding switching according to the digital input signal V_{D} in order to output one of the predetermined reference voltages V_{REF1}˜V_{REFN} as the reference voltage V_{D}_{_{—}}_{REF}.

In summary, the embodiments of the present invention can generate corresponding reference voltages through the digital reference voltage generator digitally according to various input voltages, so as to have programmable reference voltages and be suitable for different systems. More importantly, identical voltages are generated for the overcurrent limit under each input voltage.

Those skilled in the art will readily observe that numerous modifications and alterations of the device and method may be made while retaining the teachings of the invention.

What is claimed is:

1. A digital overcurrent protection device for a power supply device, the digital overcurrent protection device comprising:
a receiving end for receiving a current sensing signal;
a digital reference voltage generator for digitally generating a reference voltage;
a comparator coupled between the receiving end and the digital reference voltage generator for comparing the current sensing signal with the reference voltage in order to generate a comparison result; and
a control unit coupled to the comparator for controlling an on/off status of a power switch of the power supply device according to the comparison result.

2. The digital overcurrent protection device of claim 1, wherein the current sensing signal is provided by a current sensing unit of the power supply.

3. The digital overcurrent protection device of claim 1, wherein the digital reference voltage generator comprises a digital-to-analog converter for converting a digital input signal into a corresponding predetermined reference voltage in order to generate the reference voltage.

4. The digital overcurrent protection device of claim 3, wherein the digital reference voltage generator further comprises a digital input signal generator for generating the digital input signal.

5. The digital overcurrent protection device of claim 4, wherein the digital reference voltage generator adjusts the digital input signal according to a system requirement of the power supply.

6. The digital overcurrent protection device of claim 5, wherein the digital reference voltage generator adjusts the digital input signal according to variation of the current sensing signal.

7. The digital overcurrent protection device of claim 1, wherein the power supply is a switching power supply.

8. The digital overcurrent protection device of claim 1, wherein when the comparison result indicates the current sensing signal is higher than or equal to the reference voltage, the control unit enables to turn off the power switch.

9. The digital overcurrent protection device of claim 1, wherein when the comparison result indicates the current sensing signal is lower than the reference voltage, the control unit keeps the power switch on.

10. A power supply device with overcurrent protection, the power supply device comprising:
an input stage for filtering and rectifying an input signal in order to generate a first power signal;
a transformer having a primary side circuit coupled to the input stage and a secondary side circuit, for transforming the first power signal into a second power signal;
a power switch coupled to the primary side circuit;
a current sensing unit coupled to the power switch for detecting currents passing through the primary side circuit of the power switch in order to generate a current sensing signal;
an output stage coupled to the transformer for outputting the second power signal to a load; and
a digital overcurrent protection device coupled to the current sensing unit and the power switch, the digital overcurrent protection device comprising:
a receiving end for receiving the current sensing signal;
a digital reference voltage generator for digitally generating a reference voltage;
a comparator coupled between the receiving end and the digital reference voltage generator for comparing the current sensing signal with the reference voltage in order to generate a comparison result; and
a control unit coupled to the comparator and the power switch for controlling an on/off status of the power switch according to the comparison result.

11. The power supply of claim 10, wherein the digital reference voltage generator comprises a digital-to-analog converter for converting a digital input signal into a corresponding predetermined reference voltage in order to generate the reference voltage.

12. The power supply of claim 11, wherein the digital reference voltage generator further comprises a digital input signal generator for generating the digital input signal.

13. The power supply of claim 12, wherein the digital reference voltage generator adjusts the digital input signal according to a system requirement of the power supply.

14. The power supply of claim 13, wherein the digital reference voltage generator adjusts the digital input signal according to variation of the current sensing signal.

15. The power supply of claim 10, wherein the power supply is a switching power supply.

16. The power supply of claim 10, wherein when the comparison result indicates the current sensing signal is higher than or equal to the reference voltage, the control unit enables to turn off the power switch.

17. The power supply of claim 10, wherein when the comparison result indicates the current sensing signal is lower than the reference voltage, the control unit keeps the power switch on.

18. The power supply of claim 10, wherein the power switch is a power transistor.
